(19) United States
(12) Patent Application Publication
(10) Pub. No.: US 2022/0186094 A1
(43) Pub. Date: Jun. 16, 2022

(54) BINDER FOR PRODUCING WOOD-BASED COMGLOMERATES WITHOUT RELEASE OF FREE FORMALDEHYDE AND METHOD FOR MAKING THE BINDER

(71) Applicant: Enrico CANTI, Vallefoglia (IT)

(72) Inventor: Enrico CANTI, Vallefoglia (IT)

(21) Appl. No.: 17/598,099

(22) PCT Filed: Mar. 24, 2020
(86) PCT No.: PCT/IT2020/050072

§ 371 Date: Sep. 24, 2021

(30) Foreign Application Priority Data
Mar. 25, 2019 (IT) 102019000004309

(51) Int. Cl. C09J 161/28; C09J 161/24; B27N 1/02; B27N 3/00

(52) U.S. Cl. CPC C09J 161/28; B27N 3/002; B27N 1/02; C09J 161/24

(57) ABSTRACT

A binder for producing wood-based conglomerates without release of free formaldehyde, said binder having a total mass by weight, the total mass comprising a first quantity by weight of a compound selected from urea-formaldehyde or melamine-formaldehyde, the total mass by weight comprising a second quantity of a humic substance, which by weight is complementary of the first quantity.

### FIELD OF THE INVENTION

The invention concerns a binder for producing wood-based conglomerates without release of free formaldehyde and a method for making the binder, which can both generally be used for producing conglomerates to make products, for example in the furniture production sector, in which the release of free formaldehyde into the environment is either negligible or blocked.

### BACKGROUND OF THE INVENTION

Industrial processes have been known and used for some time to form wood-based conglomerates, typically rigid panels, with which to make products of various kinds, such as, for example, furniture components.

In particular, known industrial processes make solid conglomerates using wood shavings which are agglomerated together with cross-linkable chemical binders and which, after being subjected to cross-linking heat treatments, are able to give the masses of shavings a structural consistency, and therefore a desired shape, in addition to a specific mechanical resistance to stress.

Typically, the known binders that are used in these industrial processes are formaldehyde-based, more precisely based on a urea-formaldehyde mixture or a melamine-formaldehyde mixture, this is because these formaldehyde-based binders have considerably low costs in relation to the adhesion performances they provide.

In these mixtures, the theoretical stoichiometric quantities between urea and formaldehyde, or between melamine and formaldehyde, are typically of one formaldehyde molecule linked to one urea or melamine molecule, therefore according to a molecular ratio of 1:1.

However, it has been found that by respecting this theoretical stoichiometric ratio in the production processes, on the one hand the effectiveness of the cohesion of the binders is significantly reduced, while on the other hand the cross-linking speeds of the chemical components contained in the binder decrease, significantly slowing down the production processes.

In practice, the conglomerates produced with these binders obtained in a chemically theoretical form on the one hand do not have a high mechanical resistance, and on the other hand the quantity of time for the structural stabilization process of the conglomerates is significantly lengthened, in a manner that is not convenient for production costs.

For these reasons, currently in the processes for the production of wood-based conglomerates, the stoichiometric ratio of 1:1 between the urea or melamine molecules and the corresponding formaldehyde molecules is intentionally modified, more precisely, the quantities of formaldehyde have been increased compared to urea or to melamine, reaching up to a ratio of two molecules of formaldehyde to one of melamine or urea, that is, in other words, with considerable excess quantities of formaldehyde.

In this way, the cross-linking and conglomeration processes are forced and accelerated, improving the yield of industrial processes, and, at the same time, the characteristics of mechanical strength of the conglomerates and also of the products made with conglomerates obtained by using excess formaldehyde are higher.

However, this state of the art has some disadvantages.

One disadvantage is that, as it has been known since some time, formaldehyde is a substance with a high carcinogenic risk for living beings and, for this reason, its use as a binder in the processes of production of conglomerates is in itself dangerous and regulated by special laws which discipline its use in a very restrictive manner, reaching measures adopted in Japan that prohibit its use entirely.

Another disadvantage is that by using excess formaldehyde, the latter remains present in free form in the conglomerates obtained, even if these are structurally stabilized, and for this reason the products made with these conglomerates, for example domestic and industrial furniture, over time release free formaldehyde into the environment, polluting it over the course of their entire life cycle and exposing living beings to the risk of the arising of carcinogenic diseases.

Another disadvantage is that the technique which provides to decrease the formaldehyde content in order to limit the quantities of free formaldehyde in the conglomerates determines a significant increase in the production costs to maintain the desired physical and mechanical characteristics in the conglomerates, the reason being that it is necessary to use melamine in the production of the binder, a substance that is significantly more expensive.

To overcome these shortcomings, the use of other binders has been experimented in the production processes of wood-based conglomerates to completely replace those that contain formaldehyde.

In particular, according to a first alternative, instead of formaldehyde-based binders, the use of diphenylmethane diisocyanate (pMDI) as a binder has been tested, a substance which, however, is highly toxic and which therefore requires closed production cycles for the production of conglomerates, that is, expensive plants that have production lines completely isolated from the atmospheric environment.

Furthermore, this substance is difficult to find on the market in the large quantities required in the production processes, and its cost is much higher (up to eight times) than that of formaldehyde.

Also, diphenylmethane diisocyanate cannot be used as a co-binder of urea or melamine-formaldehyde as it is not compatible with urea-formaldehyde because it would react substantially instantly with the water that is contained in urea-formaldehyde.

Alternatively, the use of protein-based binders (soy protein) has also been tested, which however have currently not been tested comprehensively enough to provide reliable results on the characteristics and overall costs of the conglomerates produced.

Furthermore, these binders are not compatible as co-binders with urea-formaldehyde or with melamine-formaldehyde for the reason that they react in the presence of a basic environment, while urea-formaldehyde and melamine-formaldehyde react in an acidic environment.

Another alternative solution that has been tested is the use of glues based on lignin, tannins, cellulose, which, however, have an uncertain availability on the market and, as for protein-based binders, have still not been sufficiently tested.

Another alternative solution is the use of epoxy resins, which, however, have reactivity to cross-linking that is different than that of formaldehyde, they also have high costs and require significant structural modifications of the plants that currently exist for the production of wood-based conglomerates and which use formaldehyde.

### PURPOSES OF THE INVENTION

An object of the invention is to overcome the disadvantages described above, by providing a binder for producing wood-based conglomerates without release of free formaldehyde and a method for making the binder with which it is possible to make conglomerates and products, for example furniture products, which although containing reduced quantities of formaldehyde, are able to provide characteristics of adhesion and mechanical resistance equal to or greater than those obtainable with the use of binders based on urea-formaldehyde or melamine-formaldehyde, while maintaining production costs low.

Another object of the invention is to make a binder for producing wood-based conglomerates without release of free formaldehyde and a method for making the binder which does not require substantial structural modifications of the known production plants which use mixtures of urea-formaldehyde or melamine-formaldehyde.

Another object of the invention is to make a binder to produce wood-based conglomerates without release of free formaldehyde and a method for making the binder which, at the end of the life-cycle of the products made with it, allows to dispose of them without particular difficulties, corresponding costs and pollution of the environment.

According to one aspect of the invention, a binder is provided for producing wood-based conglomerates without release of free formaldehyde, in accordance with the characteristics of claim 1.

According to another aspect of the invention, a method is provided for making a binder to produce wood-based conglomerates without release of free formaldehyde, in accordance with the characteristics of claim 6.

The invention allows to obtain the following advantages:
to perfect a binder with which it is possible to produce conglomerates that have the same characteristics of mechanical and water resistance as those of conglomerates produced with formaldehyde compounds, however without them releasing free formaldehyde into the environment;
to produce conglomerates using plants of a known type without having to carry out significant structural changes to them;
to produce conglomerates with which to make objects, typically furniture components, which, at the end of their life-cycle, can be disposed of without particular difficulties and additional costs, since they are free of polluting substances.

### DESCRIPTION OF EXAMPLE EMBODIMENTS OF THE INVENTION

Other characteristics and advantages of the invention will become more evident from the detailed description of preferred, but not exclusive, embodiments of a binder for producing wood-based conglomerates without release of free formaldehyde and a method for making the binder, described in the following non-limiting examples of embodiments, in which it is understood that all the percentages mentioned are percentages by weight.

In order to accelerate the chemical reaction between the components of the binder according to the invention, in such a way that, despite the presence of smaller quantities of formaldehyde, it occurs within the standard times for the production of conglomerates for making rigid panels that have a substantially unchanged mechanical resistance, in the mass of the binder that contains a first reduced quantity of urea-formaldehyde or melamine-formaldehyde, a second quantity of a humic substance is added which does not contain it at all, and which has numerous functional groups able to accelerate the reaction of polycondensation and methylolation, also becoming inserted in the linear chains being formed, also creating cross-links between them, also leading to an increase in the mechanical and water resistance characteristics.

With the term “humic substance” we mean a substance found in nature that contains humic acids and, above all, fulvic acids.

The humic substance contains a large number of alcoholic, phenolic and carboxylic functional groups and is also able to capture the excess formaldehyde molecules.

According to the method of the invention, percentages by weight of humic substance are introduced into the mass of the binder, which consequently allow to proportionally reduce the quantity of melamine-formaldehyde or urea-formaldehyde, for the reason that these substances are not present in the humic substance.

In other words, a sort of dilution effect is generated in the mixture between the first quantity of melamine-formaldehyde or urea-formaldehyde.

The second quantity of humic substance added to the mixture to make the binder according to the invention supplies macromolecules which, after the cross-linking, make up for the reduction of urea-formaldehyde or melamine-formaldehyde which, as is known, provide the glue effect.

The humic substance, in addition to the humic and fulvic acids that it is mainly made up of, also contains a large variety of molecular components such as polysaccharides, fatty acids, polypeptides, lignins, esters, phenols, ethers, carbonyls, quinones, lipids, peroxides, various combinations of benzene, acetal, ketal, lactol and furan rings compounds, aliphatic compounds, all reactive and cross-linkable substances.

Humic acids (HAs) contain a mixture of weak aliphatic (carbon chains) and aromatic organic salts (carbon rings) which are not soluble in water in an acidic environment, but are soluble in alkaline conditions.

Humic acids, therefore, form that fraction of humic substances that are precipitate when pH=2 and decreases below the value pH=2.

From a three-dimensional perspective these complex compounds containing carbon are considered flexible linear polymers that exist as random coils with cross-linked bonds.

Typically, 35% of the humic acid (HA) molecules are aromatic (carbon rings), while the remaining components are in the form of aliphatic molecules (carbon chains).

Fulvic acids (FAs), which are molecularly very similar to humic acids, are a mixture of aromatic acids and weak aliphatics which are soluble in water at all pH conditions (acid, neutral or alkaline).

Their composition and shape are quite variable: in fact, the size of fulvic acids (HFs) is smaller than that of humic acids (HAs), with a molecular weight ranging from about 1,000 to 10,000.

In addition, fulvic acids (FHs) have an oxygen content that is twice that of humic acids (HAs). And they have many carboxylic (—COOH) and hydroxyl (—CHO) groups, which make them significantly more chemically reactive and provided with an exchange capacity that is more than double that of humic acids (HAs). This high exchange capacity is due to the total number of carboxylic groups (—COOH) present, which varies from 520 to 1,120 cmol (H+)/Kg.

In the preferred embodiment of the binder according to the invention, a second complementary quantity of fulvic acids is added to the first quantity of urea-formaldehyde or melamine-formaldehyde, due to the fact that humic acids are soluble only in a basic environment while the reactions of urea-formaldehyde and melamine-formaldehyde occur in an acidic environment, and due to the fact that, contrary to fulvic acids, as well as being able to be extracted for example from a fossil such as Leonardite, they can also be easily obtained by means of the enzymatic demolition of cellulose biomass, therefore in a renewable manner. Furthermore, the fulvic acids are already on the market in an acidic environment at pH=4.5 and, as is known, they are soluble in water at all pH conditions and, therefore, can also be used in phenol-formaldehyde reactions in a basic environment.

It should be emphasized that it would be possible to obtain the same binder, albeit in a less reactive form, also using a second quantity of humic acids, instead of fulvic acids, since if these humic acids are taken with a chemical treatment into an acidic environment with pH=4-5 with the addition of an acid, an acidic environment in which at this pH value they are in a gel state and not a precipitate, which would occur with values of pH=2 or even lower.

Thanks to the presence of numerous functional groups, together with the reaction of condensation and methylolation of the urea-formaldehyde and melamine-formaldehyde, it is possible to bind the formaldehyde present in excess in the binder even with only small dosages of fulvic acids replacing small quantities of formaldehyde based glues.

Since the chemical reactivity is increased with the addition of humic substances in the compound which, together with the quantity of urea-formaldehyde or melamine-formaldehyde, forms the mass of binder according to the invention and containing mainly fulvic acids, the pressing times for conglomeration that are currently necessary to make conglomerates with the use of glues with low formaldehyde content have been halved.

In addition, a noticeable decrease has been verified in the so-called “pot-life” of the glue at room temperature, that is, the amount of time the binder remains in a workable form before its irreversible hardening.

It has also been observed that the origin of the fulvic acids affects the pot-life of the binder.

In fact, fulvic acid can come from extraction from the fossil Leonardite, or from another liquid that contains it, for example a liquid of enzymatic origin from the processing of plant biomass, in particular of sugarcane bagasse.

This liquid has a density of about 1,300 Kg/m³ and, in addition to containing a significant quantity of fulvic acids, about 23%, it also contains 18.75% of protein substances, which being in an acidic environment are hydrolyzed into peptides, and also contains 2% of humic acids.

By using this liquid, the pot-life of the binder at room temperature is extended by more than 12 hours, while still remaining extremely reactive when hot. Ultimately, in order to modify the pot-life duration it is useful to add protein substances in the liquid that is derived from Leonardite.

Furthermore, the presence of added proteins, which after having been hydrolyzed in an acid or basic environment become amino acid peptides and lead to further cross-linking with the free formaldehyde and the same polymer molecules forming urea-formaldehyde and melamine-formaldehyde, increase the physical and mechanical characteristics of the composites.

This increase in the physical and mechanical characteristics of the composites is obtained by the fact that, as is known, by acid or basic hydrolysis the proteins give amino acids which are cyclic or acyclic organic acids in which one or more amide groups are present.

Therefore these compounds have at the same time acidic and basic characteristics (so-called amphoteric).

The binding of the acid functional group with the amide functional group of another molecule creates the peptide bond with the formation of linear polymeric chains that in the amide terminal part connect to the numerous acid groups of the macromolecule of fulvic acids, creating complex cross-linkings of a thermosetting nature.

Parallel to the cross-linking by condensation and methylolation of the urea-formaldehyde and melamine-formaldehyde molecules, with the heat the cross-linking of the amino acids with themselves and with the fulvic acid molecules occurs, and also new cross-linkings between the urea-formaldehyde or melamine-formaldehyde molecules with other functional groups of the same molecule. Therefore it would be good practice to also enrich with protein substances the liquid containing fulvic acids coming from the fossil Leonardite.

In another form of use of the binder according to the invention, it is possible to use only the enzymatic liquid containing fulvic acids and amino acid polypeptides.

The enzymatic liquid is extremely soluble in water, it can be added to the suspensions in water of urea-formaldehyde and melamine-formaldehyde or phenol-formaldehyde for impregnating the paper used for stratification of HPL laminates, both to accelerate the reaction of polymerization, and also to reduce the quantity of free formaldehyde in the derived products.

Fulvic acids are soluble at every pH value and can therefore be used in the solutions of urea-formaldehyde or melamine-formaldehyde found in an acidic environment, or in the phenol-formaldehyde which is found in a basic environment.

On the contrary, the humic acids used in the impregnation of the paper, since they are soluble only in a basic environment, are compatible to be added only to the phenol-formaldehyde since, contrary to the acidic environment, such as the impregnation of the paper with urea-melamine-formaldehyde, they would pass to a gel phase which would not be able to penetrate the fibers of the paper itself. When the humic acids are added to the glues of urea-formaldehyde and melamine-formaldehyde in the processes of conglomeration or gluing of wood laminates, no inconvenience arises since all the glue is at a high viscosity and it is irrelevant whether they are in suspension or in solution.

It should be underlined that if a liquid containing fulvic acids, for example of fossil origin, without the protein part is used, it is possible to add to them vegetable protein flours or, to avoid a depletion of food resources, use a protein flour obtained from spirulina micro-algae, the cultivation of which has long started with the aim of replacing oil in automotive fuels and for the production of plastic materials.

The binder according to the invention, in which the formaldehyde component is partly replaced in a complementary manner by the second quantity of fulvic acids, or by a mixture of fulvic acids and humic acids in an acidic environment with a pH comprised between 4 and 6, or at pH 8-9 in the case of phenol-formaldehyde, until its entire mass is reconstituted, can be used in the production of panels with recycled wood where it is not possible to maintain a low formaldehyde content, since recycled wood is already typically impregnated with it in considerable quantities.

The binder according to the invention can also be used in the production of plywood in which the content of formaldehyde-based glue is higher than that of fiber wood panels, creating, for this reason, difficulties in meeting the parameters imposed by current regulations.

In particular, in the production of curved or three-dimensional layered objects, in which, in order to obtain structural stability between the various layers subjected to curvature, it is necessary to use large quantities of formaldehyde, by using the binder according to the invention in the production cycle it is possible to halve production times, which currently are about 10 minutes with urea-formaldehyde or melamine-formaldehyde based binders, and therefore double production.

It should be noted in particular that in the production of conglomerates, legislation limiting the use of formaldehyde in the United States, which came into force on Jun. 1, 2018, has drastically restricted the permitted values of free formaldehyde content in the panels.

However, the same legislation appears to be less restrictive in relation to the production of the curved and three-dimensional objects mentioned above, the reason for this being that there are no possible alternatives to the current production technique.

However, it must be emphasized that it is precisely the curved or three-dimensional objects that people come into greater contact with on a daily basis, since they are used extensively, for example, to make anatomical seatings for offices, shells for sofas and armchairs, slats of laminated wood for beds.

Also in the interior furnishings of vehicle interiors, which typically have reduced volumes, the use of curved or three-dimensional objects is widespread, which is why it is desirable to use objects that are non-toxic and that contain the least possible quantity of formaldehyde and its compounds.

In summary, according to the invention, by adding, in any proportion, to a binder that contains a first quantity of urea-formaldehyde or melamine-formaldehyde, a second complementary quantity of a humic substance, in particular fulvic acid, the cost of which is similar to that of substances based on a formaldehyde compound, on the one hand there are no significant increases in production costs and on the other hand there is a significant reduction in the pollution caused by the presence of free formaldehyde in the objects.

In practice it has been verified that the invention achieves the intended purposes. The invention as conceived is susceptible to modifications and variants, all of which are within the scope of the inventive concept.

Furthermore, all the details can be replaced with other technically equivalent elements.

In their practical embodiment, any other materials, as well as shapes and sizes, can be used according to requirements, without departing from the main field of protection of the following claims.

1. A binder for producing wood-based conglomerates without release of free formaldehyde, said binder having a total mass by weight, said total mass comprising a first quantity by weight of a compound selected from urea-formaldehyde and/or melamine-formaldehyde, wherein said total mass by weight comprises a second quantity of a humic substance, complementary by weight of said first quantity.

2. The binder as in claim 1, wherein said first quantity is comprised between 30% and 95% by weight.

3. The binder as in claim 1, wherein said humic substance comprises fulvic acid.

4. The binder as in claim 1, wherein said humic substance comprises a mixture of humic acid and fulvic acid having an acid pH between 4 and 6 when associated with urea-formaldehyde or melamine-formaldehyde and a basic pH when associated with phenol-formaldehyde.

5. The binder as in claim 1, wherein said second quantity comprises a portion of a third quantity of proteinic substances that is a complementary portion by weight of said second quantity.

6. A method for making a binder with which to form wood-based conglomerates free of free Formaldehyde, which comprises the steps of: preparing in mixing means a first quantity of a substance based on formaldehyde or on formaldehyde compounds, wherein the method comprises adding to said first quantity, in said mixing means, a second quantity of a humic substance which is complementary by weight of said first quantity.

7. The method as in claim 6, wherein said humic substance is a fulvic acid.

8. The binder as in claim 2, wherein said second quantity comprises a portion of a third quantity of proteinic substances that is a complementary portion by weight of said second quantity.

9. The binder as in claim 3, wherein said second quantity comprises a portion of a third quantity of proteinic substances that is a complementary portion by weight of said second quantity.

10. The binder as in claim 4, wherein said second quantity comprises a portion of a third quantity of proteinic substances that is a complementary portion by weight of said second quantity.
